(19) United States
(12) Patent Application Publication
(10) Pub. No.: US 2025/0051595 A1
(43) Pub. Date: Feb. 13, 2025

(54) INKJET INK AND METHOD OF PRODUCING THE SAME

(71) Applicant: KYOCERA DOCUMENT SOLUTIONS INC., OSAKA (JP)

(72) Inventor: YU KIHARA, OSAKA (JP)

(21) Appl. No.: 18/797,471

(22) Filed: Aug. 7, 2024

(30) Foreign Application Priority Data
Aug. 8, 2023 (JP) 2023-129343

(51) Int. Cl. C09D 11/30; C09D 7/80; C09D 11/107

(52) U.S. Cl. CPC C09D 11/30; C09D 7/80; C09D 11/107

(57) ABSTRACT

An inkjet ink includes: an aqueous medium; and a pigment particle dispersed in the aqueous medium. The pigment particle includes a pigment and a cross-linked resin. The cross-linked resin is a cross-linked product of a specific resin, a first cross-linking agent, and a second cross-linking agent. The first cross-linking agent has, in its molecule, an ethylene oxide structure whose number of moles added is 1 or more and 4 or less or a propylene oxide structure whose number of moles added is 1 or more and 4 or less and two or more epoxy groups. The second cross-linking agent has, in its molecule, an ethylene oxide structure whose number of moles added is 5 or more and 15 or less and two or more epoxy groups.

### CROSS-REFERENCE TO RELATED PATENT APPLICATION

This application claims the benefit of Japanese Priority Patent Application JP 2023-129343 filed Aug. 8, 2023, the entire contents of which are incorporated herein by reference.

### FIELD OF THE DISCLOSURE

The present disclosure relates to an inkjet ink and a method of producing the same.

### BACKGROUND OF THE DISCLOSURE

Water-based inkjet inks including a pigment and an aqueous medium are used in inkjet recording apparatuses in some cases. Inkjet inks are desired to provide excellent abrasion resistance and desired image density to a formed image while preventing clogging of the nozzle of the recording head of the inkjet recording apparatus. In order to meet such a demand, for example, an inkjet ink that includes a pigment particle dispersion liquid including an azomethine metal complex pigment and a polymer dispersant has been proposed (Japanese Patent Application Laid-open No. 2019-116600).

### SUMMARY OF THE DISCLOSURE

However, even the inkjet ink disclosed in Japanese Patent Application Laid-open No. 2019-116600 cannot reliably form an image with excellent abrasion resistance and desired image density while sufficiently preventing clogging of the nozzle.

In view of the circumstances as described above, it is desirable to provide an inkjet ink that is capable of forming an image with excellent abrasion resistance and desired image density while preventing clogging of the nozzle.

According to an embodiment of the present invention, there is provided an inkjet ink, including: an aqueous medium; and a pigment particle dispersed in the aqueous medium. The pigment particle includes a pigment and a cross-linked resin. The cross-linked resin is a cross-linked product of a specific resin, a first cross-linking agent, and a second cross-linking agent. The specific resin is a neutralized product of a specific copolymer that includes a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate. A content ratio of the first repeating unit is 1 mass % or more and 65 mass % or less, a content ratio of the second repeating unit is 1 mass % or more and 60 mass % or less, a content ratio of the third repeating unit is 10 mass % or more and 40 mass % or less, and a content ratio of the fourth repeating unit is 1 mass % or more and 12 mass % or less with respect to 100 mass % of all repeating units included in the specific copolymer. An acid value of the specific copolymer is 50 mgKOH/g or more and 300 mgKOH/g or less. A mass average molecular weight of the specific copolymer is 3000 or more and 18000 or less. A neutralization ratio of the specific resin is 20% or more and 100% or less. The first cross-linking agent has, in its molecule, an ethylene oxide structure whose number of moles added is 1 or more and 4 or less or a propylene oxide structure whose number of moles added is 1 or more and 4 or less and two or more epoxy groups. Water solubility of the first cross-linking agent is 80% or more. The second cross-linking agent has, in its molecule, an ethylene oxide structure whose number of moles added is 5 or more and 15 or less and two or more epoxy groups. Water solubility of the second cross-linking agent is 80% or more. In the cross-linked resin, a ratio (C₂/C₁) of a cross-linking rate C₂ by the second cross-linking agent to a cross-linking rate C₁ by the first cross-linking agent is 18/82 or more and 82/18 or less. In the cross-linked resin, a total cross-linking rate (C₁+C₂) by the first cross-linking agent and the second cross-linking agent is 25% or more and 95% or less.

According to another embodiment of the present invention, there is provided a method of producing an inkjet ink that includes an aqueous medium and a pigment particle dispersed in the aqueous medium. The pigment particle includes a pigment and a cross-linked resin. The method of producing an inkjet ink according to the present disclosure includes: a neutralization step of neutralizing a specific copolymer to obtain a specific resin; a dispersion step of dispersing the specific resin and the pigment in water to obtain a pigment particle dispersion liquid; and a cross-linking step of cross-linking the specific resin in the pigment particle dispersion liquid with a first cross-linking agent and a second cross-linking agent to obtain the cross-linked resin. The specific copolymer includes a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate. A content ratio of the first repeating unit is 1 mass % or more and 65 mass % or less, a content ratio of the second repeating unit is 1 mass % or more and 60 mass % or less, a content ratio of the third repeating unit is 10 mass % or more and 40 mass % or less, and a content ratio of the fourth repeating unit is 1 mass % or more and 12 mass % or less with respect to 100 mass % of all repeating units included in the specific copolymer. An acid value of the specific copolymer is 50 mgKOH/g or more and 300 mgKOH/g or less. A mass average molecular weight of the specific copolymer is 3000 or more and 18000 or less. A neutralization ratio of the specific resin in the neutralization step is 20% or more and 100% or less. The first cross-linking agent has, in its molecule, an ethylene oxide structure whose number of moles added is 1 or more and 4 or less or a propylene oxide structure whose number of moles added is 1 or more and 4 or less and two or more epoxy groups. Water solubility of the first cross-linking agent is 80% or more. The second cross-linking agent has, in its molecule, an ethylene oxide structure whose number of moles added is 5 or more and 15 or less and two or more epoxy groups. Water solubility of the second cross-linking agent is 80% or more. A ratio (C₂/C₁) of a cross-linking rate C₂ by the second cross-linking agent to a cross-linking rate C₁ by the first cross-linking agent in the cross-linking step is 18/82 or more and 82/18 or less. A total cross-linking rate (C₁+C₂) of the cross-linked resin by the first cross-linking agent and the second cross-linking agent is 25% or more and 95% or less.

An inkjet ink and a method of producing an inkjet ink according to an embodiment of the present disclosure are capable of providing an inkjet ink that is capable of forming an image with excellent abrasion resistance and desired image density while preventing clogging of the nozzle.

These and other objects, features and advantages of the present disclosure will become more apparent in light of the following detailed description of best mode embodiments thereof, as illustrated in the accompanying drawings.

### DETAILED DESCRIPTION OF THE EXEMPLARY EMBODIMENTS

Embodiments of the present disclosure will be described below. Note that in the following, the measured value of the volume median diameter (D₅₀) is a value measured using a dynamic light scattering particle size distribution analyzer (“Zetasizer Nano ZS” manufactured by Malvern Panalytical Ltd.), unless otherwise specified.

In the present specification, the acid value can be obtained in accordance with the method described in Japanese Industrial Standard (JIS) K0070:1992.

The measured value of the mass average molecular weight (Mw) is a value measured using gel permeation chromatography, unless otherwise specified.

In the present specification, acrylic and methacrylic are collectively referred to as “(meth)acrylic” in some cases. In the present specification, acrylate and methacrylate are collectively referred to as “(meth)acrylate” in some cases. The components described in the present specification may each be used alone, or two or more of them may be used in combination.

### First Embodiment: Inkjet Ink

A first embodiment of the present disclosure relates to an inkjet ink (hereinafter, referred to as an ink in some cases). The ink according to this embodiment includes an aqueous medium and a pigment particle dispersed in the aqueous medium. The pigment particle includes a pigment and a cross-linked resin. The cross-linked resin is a cross-linked product of a specific resin, a first cross-linking agent, and a second cross-linking agent. The specific resin is a neutralized product of a specific copolymer that includes a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate. The content ratio of the first repeating unit is 1 mass % or more and 65 mass % or less, the content ratio of the second repeating unit is 1 mass % or more and 60 mass % or less, the content ratio of the third repeating unit is 10 mass % or more and 40 mass % or less, and the content ratio of the fourth repeating unit is 1 mass % or more and 12 mass % or less with respect to 100 mass % of all repeating units included in the specific copolymer. The acid value of the specific copolymer is 50 mgKOH/g or more and 300 mgKOH/g or less. The mass average molecular weight of the specific copolymer is 3000 or more and 18000 or less. The neutralization ratio of the specific resin is 20% or more and 100% or less. The first cross-linking agent has, in its molecule, an ethylene oxide structure whose number of moles added is 1 or more and 4 or less or a propylene oxide structure whose number of moles added is 1 or more and 4 or less and two or more epoxy groups. Water solubility of the first cross-linking agent is 80% or more. The second cross-linking agent has, in its molecule, an ethylene oxide structure whose number of moles added is 5 or more and 15 or less and two or more epoxy groups. Water solubility of the second cross-linking agent is 80% or more. A ratio (C₂/C₁) of a cross-linking rate C₂ by the second cross-linking agent to a cross-linking rate C₁ by the first cross-linking agent in the cross-linked resin is 18/82 or more and 82/18 or less. A total cross-linking rate (C₁+C₂) by the first cross-linking agent and the second cross-linking agent in the cross-linked resin is 25% or more and 95% or less.

In the present specification, the cross-linking rate refers to the ratio of the number of functional groups that actually form a cross-linked structure in the formed cross-linked product in the case where the total number of functional groups (group capable of reacting with a cross-linking agent) included in the raw material used for cross-linking is 100%. The cross-linking agents (the first cross-linking agent and the second cross-linking agent) used in the ink according to this embodiment react with mainly acid groups (particularly, —COOH). For this reason, in the ink according to this embodiment, the “total number of functional groups included in the raw material used for cross-linking” corresponds to the number of moles of carboxy groups included in the specific resin. Further, the first cross-linking agent and the second cross-linking agent used in the ink according to this embodiment have excellent reactivity with the specific resin. For this reason, the carboxy group included in the specific resin reacts with the epoxy groups included in the first cross-linking agent and the second cross-linking agent at an extremely high reaction rate. That is, the “number of functional groups that actually form a cross-linked structure in the formed cross-linked product” is substantially equal to the total number of moles of the epoxy groups included in the first cross-linking agent and the second cross-linking agent. From the above, in the ink according to this embodiment, the cross-linking rate of the cross-linked resin is substantially the same as the ratio of the total number of moles of the epoxy groups included in the first cross-linking agent and the second cross-linking agent with respect to 100% of the number of moles Y of the carboxy groups included in the specific resin.

The number of moles of the epoxy groups included in the cross-linking agent (the first cross-linking agent or the second cross-linking agent) is calculated by, for example, dividing the amount [g] of the cross-linking agent used for cross-linking the specific resin by the epoxy equivalent [g/eq.] of the cross-linking agent. The number of moles Y of the carboxy groups included in the specific resin is calculated by multiplying the amount of the specific resin used and the number of moles of the carboxy groups per 1 g of the specific resin. The number of moles of the carboxy groups per 1 g of the specific resin is calculated by dividing the acid value [mgKOH/g] of the specific copolymer that is the raw material of the specific resin by the molecular weight of KOH (56.1).

The cross-linked resin is cross-linked with the first cross-linking agent and the second cross-linking agent. That is, the molecule of the cross-linked resin has a portion that is cross-linked with the first cross-linking agent and a portion that is cross-linked with the second cross-linking agent. For this reason, the cross-linking rate of the cross-linked resin is the total cross-linking rate (C₁+C₂) of the cross-linking rate C₁ by the first cross-linking agent and the cross-linking rate C₂ by the second cross-linking agent. The cross-linking rate C₁ by the first cross-linking agent is obtained by dividing the number of moles X₁ of the epoxy groups included in the first cross-linking agent by the number of moles Y of the carboxy groups included in the specific resin. The cross-linking rate C₂ by the second cross-linking agent is obtained by dividing the number of moles X₂ of the epoxy groups included in the second cross-linking agent by the number of moles Y of the carboxy groups included in the specific resin.

In summary, in the specific resin, the cross-linking rate C₁ by the first cross-linking agent, the cross-linking rate C₂ by the second cross-linking agent, and the total cross-linking rate (C₁+C₂) are obtained by the following formulae.

Cross-linking rate C₁[%]=100×the number of moles X₁ of the epoxy groups included in the first cross-linking agent/the number of moles Y of the carboxy groups included in the specific resin

Cross-linking rate C₂[%]=100×the number of moles X₂ of the epoxy groups included in the second cross-linking agent/the number of moles Y of the carboxy groups included in the specific resin

Total cross-linking rate(C₁+C₂)[%]=C₁+C₂

Although uses of the ink according to this embodiment are not particularly limited, the ink according to this embodiment can be used for, for example, forming an image on a permeable recording medium or a non-permeable recording medium. The ink according to this embodiment is suitable for forming an image on a permeable recording medium. The permeable recording medium has excellent permeability of the ink. Examples of the permeable recording medium include a printing paper and a medium that uses a fiber as a raw material (e.g., a fabric). Examples of the printing paper include plain paper, copy paper, recycled paper, thin paper, thick paper, and glossy paper.

By having the above-mentioned configuration, the ink according to this embodiment is capable of forming an image with excellent abrasion resistance and desired image density while preventing clogging of the nozzle. The reasons for this are presumed to be as follows. It is difficult for known inks to satisfy all of the following requirements: preventing clogging of the nozzle; forming an image with desired image density; and imparting excellent abrasion resistance to an image to be formed, although one of them may be satisfied. For example, in order to prevent clogging of the nozzle in known inks, it is effective to impart high dispersion stability to pigment particles. However, an image formed by known inks including pigment particles with high dispersion stability often does not have sufficient image density, because the pigment particles penetrate deep into the recording medium together with the aqueous medium. Further, in order to impart desired image density to an image to be formed in known inks, it is effective to increase the hydrophobicity of the pigment particles. The highly hydrophobic pigment particles are difficult to penetrate deep into the recording medium. For this reason, an image formed by known inks including highly hydrophobic pigment particles is capable of exhibiting desired image density because a large amount of pigment particles stay on the surface of the recording medium. However, the image in which a large amount of pigment particles stay on the recording medium tends to have low abrasion resistance. This is because some of the pigment particles do not adhere directly to the recording medium and stay above the surface of the recording medium while being mount on the other pigment particles adhered to the recording medium. Such pigment particles are easily detached from the recording medium when an external force is applied.

On the other hand, the pigment particle included in the ink according to this embodiment includes a pigment and a cross-linked resin. The cross-linked resin is a cross-linked product of a specific resin, a first cross-linking agent, and a second cross-linking agent. The specific resin is a neutralized product of a specific copolymer. Here, the cross-linked resin includes a relatively large number of acid groups because the acid value of the specific copolymer that is used as a raw material is relatively high. Further, the acid group of the cross-linked resin is moderately neutralized. The acid group (particularly, neutralized acid group) is highly hydrophilic. For this reason, the cross-linked resin has a relatively high hydrophilicity. Further, the first cross-linking agent and the second cross-linking agent each have an ethylene oxide structure or a propylene oxide structure having a structure that has a relatively high hydrophilicity. Of these, the ethylene oxide structure whose number of moles added is relatively large of the second cross-linking agent is particularly highly hydrophilic. Meanwhile, the propylene oxide structure or ethylene oxide structure whose number of moles added is relatively small of the first cross-linking agent is not so highly hydrophilic. Since the specific resin is cross-linked with such a first cross-linking agent and second cross-linking agent with different hydrophilicities at a predetermined ratio, the hydrophilicity is adjusted to an appropriate range. Further, each of the first cross-linking agent and the second cross-linking agent has high water solubility and thus is capable of efficiently reacting with the specific resin during the cross-linking reaction. Further, the cross-linked resin is capable of efficiently covering the pigment particle because the molecular size of the specific copolymer that is used as a raw material is appropriate. Further, the cross-linked resin has a cross-linked structure and thus is difficult to detach from the pigment particles.

Further, the specific copolymer that is used as a raw material of the cross-linked resin includes the first repeating unit to the fourth repeating unit at a predetermined content ratio. The first repeating unit derived from α-methylstyrene moderately increases the affinity between the cross-linked resin and the pigment particles. The second repeating unit derived from styrene imparts moderate hydrophobicity to the cross-linked resin to adjust the dispersion stability of the pigment particles. The third repeating unit derived from (meth)acrylic acid and the fourth repeating unit derived from alkylene glycol (meth)acrylate or dialkylene glycol (meth)acrylate impart moderate hydrophilicity to the cross-linked resin and imparts dispersion stability to the pigment particles. As a result, the pigment particles included in the ink according to this embodiment have a good balance of hydrophilicity and dispersion stability. For this reason, the ink according to this embodiment is capable of forming an image with excellent abrasion resistance and desired image density while preventing clogging of the nozzle.

The ink according to this embodiment will be described below in more detail. Note that the components described below may be used alone or two or more of them may be used in combination.

### [Content Ratio of Solids in Supernatant Liquid]

Of the cross-linked resins included in the ink according to this embodiment, some cross-linked resins are detached from the pigment particles during production or preservation of the ink according to this embodiment and free in the aqueous medium in some cases. Such a cross-linked resin that is free in the aqueous medium will be referred to as a free resin. A solid contained in the supernatant liquid obtained by centrifuging the ink according to this embodiment at 1,050,000 G for 3 hours can be regarded as a free resin. The free resin can cause clogging of the nozzle. For this reason, in the ink according to this embodiment, the content ratio of the free resin is favorably low. However, in the ink according to this embodiment, a free resin is inevitably generated and is difficult to remove completely. Further, the free resin also has a function of optimizing the abrasion resistance of an image formed by the ink according to this embodiment and thus does not necessarily need to be completely removed.

From the above, in the ink according to this embodiment, the content ratio of solids in the supernatant liquid obtained by centrifuging at 1,050,000 G for 3 hours is favorably 2.0 mass % or less, more favorably 0.1 mass % or more and 1.5 mass % or less, and still more favorably 0.5 mass % or more and 1.0 mass % or less. By setting the above-mentioned content ratio of solids in the supernatant liquid to 0.1 mass % or more, it is possible to impart further excellent abrasion resistance to an image formed by the ink according to this embodiment. By setting the above-mentioned content ratio of solids in the supernatant liquid to 2.0 mass % or less, the ink according to this embodiment is capable of more effectively preventing clogging of the nozzle. The above-mentioned content ratio of solids can be measured by the method described in Examples or a method according thereto.

### [Pigment Particle]

The pigment particle includes a pigment and a cross-linked resin. The pigment particle includes, for example, a core including a pigment and a cross-linked resin covering the core. The total content ratio of the pigment and the cross-linked resin in the pigment particle is favorably 90 mass % or more, more favorably 100 mass %.

From the viewpoint of optimizing the color density, hue, or stability of the ink according to this embodiment, the volume median diameter of the pigment particles is favorably 30 nm or more and 200 nm or less, more favorably 80 nm or more and 130 nm or less.

In the ink according to this embodiment, the content ratio of the pigment particles is favorably 6.0 mass % or more and 20.0 mass % or less, more favorably 10.0 mass % or more and 15.0 mass % or less. By setting the content ratio of the pigment particles to 6.0 mass % or more, it is easier for the ink according to this embodiment to form an image with desired image density. Further, by setting the content ratio of the pigment particles to 20.0 mass % or less, it is possible to optimizing the fluidity of the ink according to this embodiment.

### (Pigment)

Examples of the pigment include a yellow pigment, an orange pigment, a red pigment, a blue pigment, a purple pigment, and a black pigment. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202). Examples of the blue pigment include C.I. Pigment Blue (15, more specifically 15:3). Examples of the purple pigment include C.I. Pigment Violet (19, 23, and 33). Examples of the black pigment include C.I. Pigment Black (7).

In the ink according to this embodiment, the content ratio of the pigment is favorably 3.0 parts by mass or more and 15.0 parts by mass or less, more favorably 7.0 parts by mass or more and 12.0 parts by mass or less. The content ratio of the pigment in the pigment particle is favorably 45 mass % or more and 80 mass % or less, more favorably 55 mass % or more and 70 mass % or less.

### (Cross-Linked Resin)

The cross-linked resin covers, for example, the pigment in the pigment particle. The cross-linked resin is a cross-linked product of a specific resin, a first cross-linking agent, and a second cross-linking agent. The total cross-linking rate (C₁+C₂) of the cross-linked resin by the first cross-linking agent and the second cross-linking agent is 25% or more an 90% or less, favorably 35% or more and 65% or less, and more favorably 35% or more and 45% or less. By setting the cross-linking rate of the cross-linked resin to 25% or more, it is possible to prevent the cross-linked resin from being detached from the pigment particle. By setting the total cross-linking rate (C₁+C₂) of the cross-linked resin to 90% or less, it is possible to optimize the hydrophilicity and dispersion stability of the pigment particles. Note that the cross-linking rate of the cross-linked resin can be calculated by the method described in Examples or a method according thereto

In the ink according to this embodiment, the content ratio of the cross-linked resin is favorably 0.5 mass % or more and 10.0 mass % or less, more favorably 2.0 mass % or more and 4.5 mass % or less. By setting the content ratio of the cross-linked resin to 0.5 mass % or more, it is possible to further optimize the hydrophilicity and dispersion stability of the pigment particles. By setting the content ratio of the cross-linked resin to 10.0 mass % or more, it is possible to suppress the generation of the free resin.

In the pigment particles, the content of the cross-linked resin with respect to 100 parts by mass of the pigment is favorably 25 parts by mass or more and 60 parts by mass or less, more favorably 30 parts by mass or more and 45 parts by mass or less. By setting the content of the cross-linked resin with respect to 100 parts by mass of the pigment to 25 parts by mass or more and 60 parts by mass or less, it is possible to further optimize the hydrophilicity and dispersion stability of the pigment particles.

### (Specific Resin)

The specific resin is a neutralized product of a specific copolymer. The neutralization ratio of the specific resin is 20% or more and 100% or less, favorably 40% or more and 95% or less, and more favorably 50% or more and 70% or less. By setting the neutralization ratio of the specific resin to 20% or more and 100% or less, it is possible to impart moderately high hydrophilicity to the cross-linked resin and optimize the hydrophilicity and dispersion stability of the pigment particles.

The specific resin favorably contains alkali metal atoms. That is, the specific resin is favorably a neutralized product obtained by neutralizing the specific copolymer by a neutralizer containing alkali metal atoms. The alkali metal atom does not volatilize from the ink according to this embodiment even if the ink according to this embodiment is exposed to a dry condition. For this reason, since the specific copolymer is neutralized by a neutralizer containing alkali metal atoms, the neutralized state (hydrophilicity) of the cross-linked resin is maintained even if the ink according to this embodiment is exposed to a dry condition. As the alkali metal atom, a potassium atom or a sodium atom is favorable. As the neutralizer, a hydroxide containing the alkali metal atom is favorable, and NaOH or KOH is more favorable.

### (Specific Copolymer)

The mass average molecular weight of the specific copolymer is favorably 3000 or more and 18000 or less, more favorably 5000 or more and 12000 or less, and still more favorably 8000 or more and 10000 or less. By setting the mass average molecular weight of the specific resin to 3000 or more and 18000 or less, the cross-linked resin is capable of efficiently covering the pigment particle. As a result, it is possible to prevent the cross-linked resin from being detached from the pigment particle.

The acid value of the specific copolymer is 50 mgKOH/g or more and 300 mgKOH/g or less, favorably 100 mgKOH/g or more and 200 mgKOH/g or less, and more favorably 150 mgKOH/g or more and 200 mgKOH/g or less. By setting the acid value of the specific copolymer to 50 mgKOH/g or more and 300 mgKOH/g or less, it is possible to easily introduce the cross-linked structure sufficiently into the cross-linked resin and optimize the hydrophilicity and dispersion stability of the pigment particles. By setting the acid value of the specific copolymer to 300 mgKOH/g or less, it is possible to prevent the hydrophilicity and dispersion stability of the pigment particles from becoming excessively high. As a result, it is possible to impart excellent abrasion resistance and desired image density to an image formed by the ink according to this embodiment.

The specific copolymer includes a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate.

Examples of alkylene glycol (meth)acrylate include ethylene glycol (meth)acrylate, propylene glycol (meth)acrylate, and butylene glycol (meth)acrylate, and ethylene glycol (meth)acrylate is favorable.

Examples of dialkylene glycol (meth)acrylate include diethylene glycol (meth)acrylate, dipropylene glycol (meth)acrylate, and dibutylene glycol (meth)acrylate, and dipropylene glycol (meth)acrylate.

The content ratio of the first repeating unit derived from α-methylstyrene is 1 mass % or more and 65 mass % or less, favorably 15 mass % or more and 55 mass % or less, more favorably 25 mass % or more and 50 mass % or less, and still more favorably 40 mass % or more and 48 mass % or less with respect to 100 mass % of all repeating units included in the specific copolymer. By setting the content ratio of the first repeating unit to 1 mass % or more and 65 mass % or less, it is possible to further optimize the hydrophilicity and dispersion stability of the pigment particles.

The content ratio of the second repeating unit derived from styrene is 1 mass % or more and 60 mass % or less, favorably 10 mass % or more and 40 mass % or less, and more favorably 15 mass % or more and 27 mass % or less with respect to 100 mass % of all repeating units included in the specific copolymer. By setting the content ratio of the second repeating unit to 1 mass % or more and 60 mass % or less, it is possible to further optimize the hydrophilicity and dispersion stability of the pigment particles.

The content ratio of the third repeating unit derived from (meth)acrylic acid is 10 mass % or more and 40 mass % or less, favorably 20 mass % or more and 35 mass % or less, and more favorably 25 mass % or more and 32 mass % or less with respect to 100 mass % of all repeating units included in the specific copolymer. By setting the content ratio of the third repeating unit to 10 mass % or more and 40 mass % or less, it is possible to further optimize the hydrophilicity and dispersion stability of the pigment particles.

The content ratio of the fourth repeating unit derived from alkylene glycol (meth)acrylate or dialkylene glycol (meth)acrylate is 1 mass % or more and 12 mass % or less, more favorably 4 mass % or more and 11 mass % or less, and more favorably 4 mass % or more and 8 mass % or less with respect to 100 mass % of all repeating units included in the specific copolymer. By setting the content ratio of the fourth repeating unit to 1 mass % or more and 12 mass % or less, it is possible to further optimize the hydrophilicity and dispersion stability of the pigment particles.

It is favorable that the content ratio of the first repeating unit is 15 mass % or more and 55 mass % or less, the content ratio of the second repeating unit is 10 mass % or more and 40 mass % or less, the content ratio of the third repeating unit is 20 mass % or more and 35 mass % or less, and the content ratio of the fourth repeating unit is 4 mass % or more and 11 mass % or less with respect to 100 mass % of all repeating units included in the specific copolymer.

The specific copolymer may be a random polymer or a block polymer. The specific copolymer is favorably a random polymer.

As the composition of the monomer that is used as a raw material of the specific copolymer, one of compositions 1 to 3 shown in the following Table 1 is favorable. The numerical range described in the following Table 1 indicates the numerical range of the content ratio [mass %] of each monomer. For example, the composition 1 includes 20 mass % or more and 24 mass % or less of styrene, 42 mass % or more and 46 mass % or less of α-methylstyrene, 4 mass % or more and 8 mass % or more of ethylene glycol acrylate, and 25 mass % or more and 30 mass % or less of methacrylic acid.

TABLE 1

| | | | Ethylene | Dipropylene | | (Meth) |
|---|---|---|---|---|---|---|
| | | α- | glycol | glycol | Acrylic | acrylic |
| | Styrene | methylstyrene | acrylate | acrylate | acid | acid |
| Composition 1 | 20-24 | 42-46 | 4-8 | — | — | 25-30 |
| Composition 2 | 57-63 | 22-26 | — | 9-13 | 14-17 | — |
| Composition 3 | 27-33 | 27-33 | 1-3 | — | — | 37-43 |

### (First Cross-Linking Agent)

The first cross-linking agent has, in its molecule, an ethylene oxide structure whose number of moles added is 1 or more and 4 or less or a propylene oxide structure whose number of moles added is 1 or more and 4 or less and two or more epoxy groups. The water solubility of the first cross-linking agent is 80% or more.

The water solubility of the first cross-linking agent is favorably 90% or more, and more favorably 98% or more. By setting the water solubility of the first cross-linking agent to 90% or more, it is possible to further optimize the hydrophilicity and dispersion stability of the pigment particles.

The water solubility of the first cross-linking agent is a ratio of a mass A (100×A/10 g) of the first cross-linking agent dissolved in water to the total amount (10 g) of the first cross-linking agent when 10 g of the first cross-linking agent and 90 g of water are mixed at 25° C. For example, in the case where 10 g of the first cross-linking agent and 90 g of water are mixed at 25° C., 9 g of the first cross-linking agent is dissolved in water, and 1 g of the first cross-linking agent is precipitated without being dissolved in water (mass A: 9 g), the water solubility is 90%. Note that the water solubility of the second cross-linking agent is also measured in the same manner.

In the first cross-linking agent, the number of epoxy groups in the molecule is favorably 2 or more and 8 or less, more favorably 2 or more and 3 or less. In the first cross-linking agent, the number of moles added in the ethylene oxide structure or propylene oxide structure in the molecule is favorably 1 or more and 3 or less, more favorably 2 or more and 3 or less.

Examples of the first cross-linking agent include propylene glycol diglycidylether, polypropylene glycol diglycidylether, ethylene glycol diglycidylether, and polyethylene glycol diglycidylether.

As the first cross-linking agent, a compound represented by the general formula (1-A) or (1-B) is favorable, and a compound represented by the chemical formula (1-A1), (1-B1), (1-B2), or (1-B3) is more favorable. In the general formula (1-A), n represents an integer of 1 or more and 4 or less. In the general formula (1-B), m represents an integer of 1 or more and 4 or less.

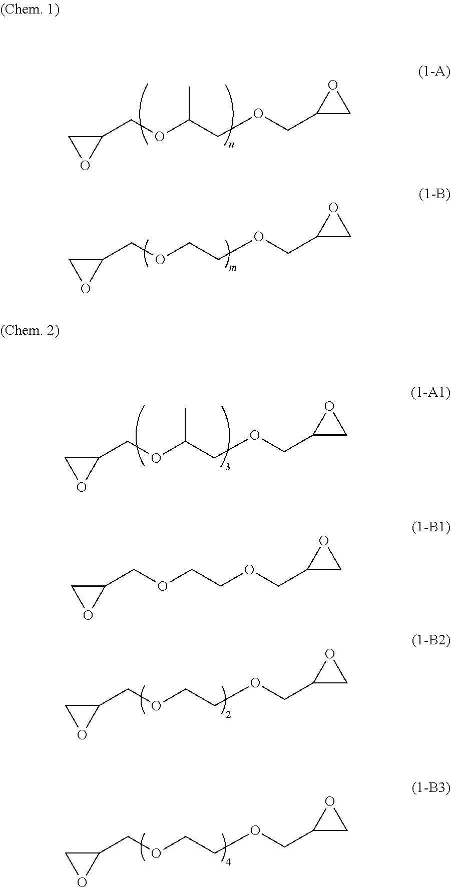

The epoxy equivalent of the first cross-linking agent is favorably 100 g/eq. or more and 230 g/eq. or less, more favorably 120 g/eq. or more and 190 g/eq. or less, and still more favorably 150 g/eq. or more and 170 g/eq. or less. Note that the epoxy equivalent can be obtained in accordance with, for example, the method described in Japanese Industrial Standard (JIS) K7236:2009.

The cross-linking rate C₁ of the cross-linked resin by the first cross-linking agent is favorably 5% or more and 75% or less, more favorably 10% or more and 45% or less, and still more favorably 14% or more and 25% or less. By setting the cross-linking rate C₁ to 5% or more and 75% or less, it is possible to further optimize the hydrophilicity and dispersion stability of the pigment particles.

### (Second Cross-Linking Agent)

The second cross-linking agent has, in its molecule, an ethylene oxide structure whose number of moles added is 5 or more and 15 or less and two or more epoxy groups. The water solubility of the second cross-linking agent is 80% or more.

The water solubility of the second cross-linking agent is favorably 90% or more, more favorably 98% or more. By setting the water solubility of the second cross-linking agent to 90% or more, it is possible to further optimize the hydrophilicity and dispersion stability of the pigment particles.

In the second cross-linking agent, the number of epoxy groups in the molecule is favorably 2 or more and 8 or less, more favorably 2 or more and 3 or less. In the second cross-linking agent, the number of moles added in the ethylene oxide structure in the molecule is favorably 7 or more and 14 or less, more favorably 9 or 13.

Examples of the second cross-linking agent include polyethylene glycol diglycidylether.

As the second cross-linking agent, a compound represented by the general formula (2-A) is favorable, and a compound represented by the chemical formula (2-A1) or (2-A2) is more favorable. In the general formula (2-A), s represents an integer of 5 or more and 15 or less.

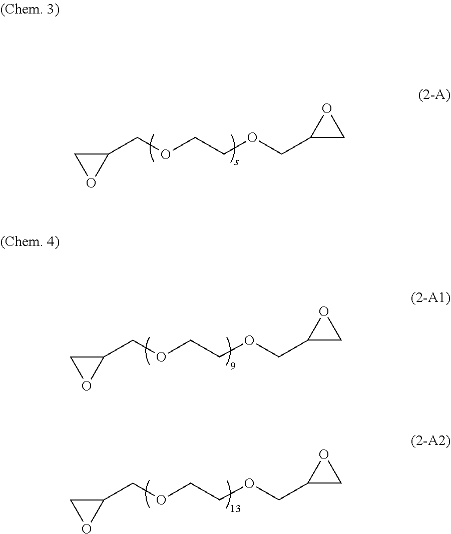

The epoxy equivalent of the second cross-linking agent is favorably 250 g/eq. or more and 450 g/eq. or less, more favorably 250 g/eq. or more and 400 g/eq. or less, and still more favorably 250 g/eq. or more and 300 g/eq. or less.

The cross-linking rate C₂ of the cross-linked resin by the second cross-linking agent is favorably 5% or more and 75% or less, more favorably 10% or more and 45% or less, and still more favorably 14% or more and 25% or less. By setting the cross-linking rate C₂ to 5% or more and 75% or less, it is possible to further optimize the hydrophilicity and dispersion stability of the pigment particles.

In the cross-linked resin, the ratio (C₂/C₁) of the cross-linking rate C₂ by the second cross-linking agent to the cross-linking rate C₁ by the first cross-linking agent is 18/82 or more and 82/18 or less, favorably 30/70 or more and 70/30 or less, and more favorably 45/55 or more and 55/45 or less. By setting the ratio (C₂/C₁) to 18/82 or more and 82/18 or less, it is possible to optimize the hydrophilicity and dispersion stability of the pigment particles.

The cross-linked resin may have a cross-linked structure derived from a different cross-linked resin other than the first cross-linking agent and the second cross-linking agent as long as the amount of the different cross-linked resin is small. In the cross-linked resin, a ratio (100×(C₁+C₂)/CALL) of the total cross-linking rate (C₁+C₂) by the first cross-linking agent and the second cross-linking agent to a total cross-linking rate CALL by all of the cross-linking agents (the first cross-linking agent, the second cross-linking agent, and the different cross-linking agent) is favorably 90% or more, more favorably 99% or more, and still more favorably 100%.

### [Aqueous Medium]

The aqueous medium included in the ink according to this embodiment is a medium including water. The aqueous medium may function as a solvent or a dispersion medium. Specific examples of the aqueous medium include an aqueous medium that includes water and a water-soluble organic solvent.

### (Water)

In the ink according to this embodiment, the content ratio of water is favorably 25.0 mass % or more and 80.0 mass % or less, more favorably 35.0 mass % or more and 60.0 mass % or less.

### (Water-Soluble Organic Solvent)

Examples of the water-soluble organic solvent include a glycol compound, a triol compound, a glycolether compound, a lactam compound, a nitrogen-containing compound, an acetate compound, thiodiglycol, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. As the glycol compound, ethylene glycol, diethylene glycol, 2-ethyl-1,2-hexanediol, 3-methyl-1,5-pentanediol, 1,3-propanediol, 1,5-pentanediol, or propylene glycol is favorable.

Examples of the triol compound include glycerin and 1,2,3-butanetriol.

Examples of the glycolether compound include diethyl diglycol, diethylene glycol monobutylether, ethylene glycol monomethylether, ethylene glycol monobutylether, diethylene glycol monomethylether, diethylene glycol monoethylether, diethylene glycol diethylether (diethyl diglycol), triethylene glycol monomethylether, triethylene glycol monoethylether, triethylene glycol monobutylether, and propylene glycol monomethylether. As the glycolether compound, triethylene glycol monobutylether is favorable.

Examples of the lactam compound include 2-pyrrolidone and N-methyl-2-pyrrolidone. As the lactam compound, 2-pyrrolidone is favorable.

Examples of the nitrogen-containing compound include 1,3-dimethylimidazolidinone, formamide, and dimethylformamide.

Examples of the acetate compound include diethylene glycol monoethylether acetate.

As the water-soluble organic solvent, glycerin, a glycol compound, a glycolether compound, or a lactam compound is favorable, and glycerin, 1,3-propanediol, 1,5-pentanediol, 3-methyl-1,5-pentanediol, ethylene glycol, triethylene glycol monobutylether, diethyl diglycol, or 2-pyrrolidone is more favorable.

As the water-soluble organic solvent, the following mixed organic solvents 1 to 3 are favorable. In the following, the numerical range shown in parentheses after each component indicates the favorable content ratio of each component in the ink according to this embodiment.
Mixed organic solvent 1: ethylene glycol (18.0 mass % or more and 22.0 mass % or less) and diethyl diglycol (13.0 mass % or more and 17.0 mass % or less)
Mixed organic solvent 2: glycerin (8.0 mass % or more and 11.0 mass % or less), triethylene glycol monobutylether (10.0 mass % or more and 14.0 mass % or less), 3-methyl-1,5-pentanediol (10.0 mass % or more and 14.0 mass % or less), and 2-pyrrolidone (0.5 mass % or more and 3.0 mass % or less)
Mixed organic solvent 3: triethylene glycol monobutylether (7.0 mass % or more and 9.0 mass % or less), 2-pyrrolidone (1.0 mass % or more and 3.0 mass % or less), 1,3-propanediol (11.0 mass % or more and 14.0 mass % or less), and 1,5-pentanediol (11.0 mass % or more and 14.0 mass % or less)

The content ratio of the water-soluble organic solvent in the ink according to this embodiment is favorably 10.0 mass % or more and 50.0 mass % or less, more favorably 30.0 mass % or more and 40.0 mass % or less.

### [Surfactant]

The ink according to this embodiment favorably further includes a surfactant. The surfactant is capable of optimizing the permeability (wettability) of the ink according to this embodiment to the recording medium. Examples of the surfactant include an anionic surfactant, a cationic surfactant, and a nonionic surfactant. As the surfactant, a nonionic surfactant is favorable.

Examples of the nonionic surfactant include polyoxyethylene dodecylether, polyoxyethylene hexadecylether, polyoxyethylene nonylphenylether, polyoxyethylene sorbitan monooleate ether, monodecanoyl sucrose, and an ethylene oxide adduct of acetylene glycol. As the nonionic surfactant, an ethylene oxide adduct of acetylene glycol is favorable.

The content ratio of the surfactant in the ink according to this embodiment is favorably 0.05 mass % or more and 3.0 mass % or less, more favorably 0.1 mass % or more and 0.5 mass % or less.

### Other Components

The ink according to this embodiment may further include, as necessary, known additives (e.g., a dissolution stabilizer, an anti-drying agent, an antioxidant, a viscosity adjustor, a pH adjuster, and an antifungal agent).

### Second Embodiment: Method of Producing Ink

A second embodiment of the present disclosure relates to a method of producing an ink. The method of producing an ink according to this embodiment is a method of producing an ink that includes an aqueous medium and a pigment particle dispersed in the aqueous medium. The pigment particle includes a pigment and a cross-linked resin. The method of producing an ink according to this embodiment includes a neutralization step of neutralizing a specific copolymer to obtain a specific resin, a dispersion step of dispersing the specific resin and the pigment in water to obtain a pigment particle dispersion liquid, and a cross-linking step of cross-linking the specific resin in the pigment particle dispersion liquid with a first cross-linking agent and a second cross-linking agent to obtain a cross-linked resin. The specific copolymer includes a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate. The content ratio of the first repeating unit is 1 mass % or more and 65 mass % or less, the content ratio of the second repeating unit is 1 mass % or more and 60 mass % or less, the content ratio of the third repeating unit is 10 mass % or more and 40 mass % or less, and the content ratio of the fourth repeating unit is 1 mass % or more and 12 mass % or less with respect to 100 mass % of all repeating units included in the specific copolymer. The acid value of the specific copolymer is 50 mgKOH/g or more and 300 mgKOH/g or less. The mass average molecular weight of the specific copolymer is 3000 or more and 18000 or less. The neutralization ratio of the specific resin in the neutralization step is 20% or more and 100% or less. The first cross-linking agent has, in its molecule, an ethylene oxide structure whose number of moles added is 1 or more and 4 or less or a propylene oxide structure whose number of moles added is 1 or more and 4 or less and two or more epoxy groups. The water solubility of the first cross-linking agent is 80% or more. The second cross-linking agent has, in its molecule, an ethylene oxide structure whose number of moles added is 5 or more and 15 or less and two or more epoxy groups. The water solubility of the second cross-linking agent is 80% or more. In the cross-linking step, the ratio (C₂/C₁) of the cross-linking rate C₂ by the second cross-linking agent to the cross-linking rate C₁ by the first cross-linking agent is 18/82 or more and 82/18 or less. The total cross-linking rate (C₁+C₂) of the cross-linked resin by the first cross-linking agent and the second cross-linking agent is 25% or more and 95% or less.

The method of producing an ink according to this embodiment is suitable as a method of producing the ink according to the first embodiment. In the method of producing an ink according to this embodiment, since an aqueous medium, a pigment particle, a pigment, a cross-linked resin, a specific copolymer, a first cross-linking agent, and a second cross-linking agent are the same as those in the first embodiment, description thereof is omitted. The method of producing an ink according to this embodiment favorably includes a centrifugation step of centrifuging the pigment particle dispersion liquid after the cross-linking step to obtain a precipitate, and a redispersion step of redispersing the precipitate in water. Each step will be described below.

### (Neutralization Step)

In this step, the specific copolymer is neutralized to obtain a specific resin. Examples of the method of neutralizing the specific copolymer include a method of mixing the specific copolymer and a neutralizer (e.g., an aqueous alkaline solution). Examples of the aqueous alkaline solution include an aqueous sodium hydroxide solution and an aqueous potassium hydroxide solution.

### (Dispersion Step)

In this step, the specific resin and the pigment are dispersed in water to obtain a pigment particle dispersion liquid. In detail, first, the specific resin, the pigment, and water are mixed to prepare a mixed solution. Next, the mixed solution is dispersed. Examples of the dispersing apparatus to be used for dispersion include a wet dispersing apparatus such as a media disperser.

The content ratio of the specific resin in the mixed solution is, for example, 5.0 mass % or more and 25.0 mass % or less. The content ratio of the pigment in the mixed solution is, for example, 1.0 mass % or more and 10.0 mass % or less. In this step, it is favorable to add an antifoaming agent to the mixed solution. The content ratio of the antifoaming agent in the mixed solution is, for example, 0.01 mass % or more and 0.1 mass % or less.

In this step, it is favorable to filter the obtained pigment particle dispersion liquid using a filter (e.g., a pore size of 5 μm) to remove coarse particles.

### (Cross-Linking Step)

In this step, the specific resin in the pigment particle dispersion liquid is cross-linked with a first cross-linking agent and a second cross-linking agent to obtain a cross-linked resin. In detail, the carboxy group included in the specific resin is caused to be cross-linked with the epoxy groups included in the first cross-linking agent and the second cross-linking agent. As a result, a cross-linked resin that is the reaction product of the first cross-linking agent, the second cross-linking agent, and the specific resin, is generated. In this step, for example, after adding the first cross-linking agent and the second cross-linking agent to the pigment particle dispersion liquid, the pigment particle dispersion liquid is heated while being stirred. The heating temperature may be, for example, 70° C. or more and 95° C. or less. The heating time may be, for example, 2 hours or more and 6 hours or less.

In this step, the amount of the first cross-linking agent added with respect to 100.0 parts by mass of the specific resin is favorably 3.0 parts by mass or more and 40.0 parts by mass or less, more favorably 5.0 parts by mass or more and 20.0 parts by mass or less, and still more favorably 10.0 parts by mass or more and 16.0 parts by mass or less.

In this step, the amount of the second cross-linking agent added with respect to 100.0 parts by mass of the specific resin is favorably 5.0 parts by mass or more and 80.0 parts by mass or less, more favorably 10.0 parts by mass or more and 40.0 parts by mass or less, and still more favorably 15.0 parts by mass or more and 25.0 parts by mass or less.

The pigment particle dispersion liquid after this step may be subjected to the centrifugation step described below or may be used as an ink after adding, as necessary, another component (more specifically, at least one of water, an organic solvent, a surfactant, a dissolution stabilizer, a moisturizing agent, a penetrating agent, or a viscosity adjustor).

### (Centrifugation Step)

In this step, the pigment particle dispersion liquid after the cross-linking step is centrifuged to obtain a precipitate. The precipitate includes a pigment particle. The supernatant liquid includes a free resin. The centrifugation conditions may be, for example, a rotational speed of 10000 rpm or more and 100000 rpm or less and the centrifugation time of 12 hours or more and 48 hours or less.

### (Redispersion Step)

In this step, the precipitate is redispersed in water. As a result, an ink is obtained. Note that in this step, as necessary, another component (more specifically, at least one of an organic solvent, a surfactant, a dissolution stabilizer, a moisturizing agent, a penetrating agent, or a viscosity adjustor) may be further added to the dispersion liquid of the precipitate.

By further including the centrifugation step and the redispersion step, the method of producing an ink according to this embodiment is capable of reducing the amount of the free resin in the ink to be produced.

In the method of producing an ink according to this embodiment, the ink obtained in the cross-linking step or the redispersion step may be treated with a filter (e.g., a filter having a pore size of 5 μm or less). This allows foreign substances and coarse particles in the ink to be removed.

### EXAMPLES

Examples of the present disclosure will be described below. However, the present disclosure is not limited to the following Examples.

In Examples, various cross-linking rates of the cross-linked resin were calculated by the following method. First, the number of moles X₁ of the epoxy groups included in the first cross-linking agent was calculated. The number of moles X₁ of the epoxy groups included in the first cross-linking agent was calculated by dividing the amount [g] of the first cross-linking agent used by the epoxy equivalent [g/eq.] of the first cross-linking agent. Similarly, the number of moles X₂ of the epoxy groups included in the second cross-linking agent was calculated by dividing the amount [g] of the second cross-linking agent used by the epoxy equivalent [g/eq.] of the second cross-linking agent. Next, the number of moles Y of the carboxy groups included in the specific resin was calculated. The number of moles Y of the carboxy groups included in the specific resin was calculated by multiplying the amount of the specific resin used and the number of moles of the carboxy groups per 1 g of the specific resin. The number of moles of the carboxy groups per 1 g of the specific resin was calculated by dividing the acid value of the specific resin by the molecular weight of KOH (56.1). Next, the various cross-linking rates of the cross-linked resin were calculated by applying the values obtained as described above to the following formulae.

Cross-linking rate C₁[%]=100×the number of moles X₁ of the epoxy groups included in the first cross-linking agent/the number of moles Y of the carboxy groups included in the specific resin

Cross-linking rate C₂[%]=100×the number of moles X₂ of the epoxy groups included in the second cross-linking agent/the number of moles Y of the carboxy groups included in the specific resin

Total cross-linking rate(C₁+C₂)[%]=C₁+C₂

(Preparation of Copolymer (r-1))

100.0 parts by mass of isopropyl alcohol and 250.0 parts by mass of methyl ethyl ketone were added to a four-necked flask equipped with a stirrer, a nitrogen introduction tube, a capacitor, and a dropping funnel. Separately, 20.0 parts by mass of styrene, 40.0 parts by mass of α-methylstyrene, 5.0 parts by mass of ethylene glycol acrylate, 25.0 parts by mass of methacrylic acid, and 0.3 parts by mass of azobisisobutyronitrile (AIBN, a polymerization initiator) were mixed to prepare a monomer solution. Further, 150.0 parts by mass of methyl ethyl ketone and 0.1 parts by mass of AIBN were mixed to prepare a methyl ethyl ketone solution.

Next, a nitrogen gas was introduced into the above-mentioned four-necked flask to create a nitrogen atmosphere. Next, while heating the content of the above-mentioned four-necked flask at 70° C. to reflux, the total amount of the above-mentioned monomer solution was supplied into the above-mentioned four-necked flask over 2 hours using a dropping funnel. After supplying the monomer solution, the content of the above-mentioned four-necked flask was further heated at 70° C. to reflux over 6 hours. Next, while heating the content of the above-mentioned four-necked flask at 70° C. to reflux, the total amount of the above-mentioned methyl ethyl ketone solution was supplied into the above-mentioned four-necked flask over 15 minutes using a dropping funnel. After supplying the methyl ethyl ketone solution, the content of the above-mentioned four-necked flask was further heated at 70° C. to reflux over 5 hours. In this way, an aqueous copolymer solution including a copolymer (r-1) that is the specific copolymer was obtained. By distilling off methyl ethyl ketone and isopropyl alcohol from the aqueous copolymer solution to isolate the copolymer (r-1).

### (Measurement of Acid Value)

The acid value of the copolymer (r-1) was measured in accordance with the method described in Japanese Industrial Standard (JIS) K0070:1992 (Test methods for acid value, saponification value, ester value, iodine value, hydroxyl value and unsaponifiable matter of chemical products). The measurement results are shown in the following Table 2.

### (Measurement of Mass Average Molecular Weight)

The mass average molecular weight (Mw) of the copolymer (r-1) was measured by gel permeation chromatography (GPC) under the following conditions. The measurement results are shown in the following Table 2.

### (Gpc Conditions)

Measuring apparatus: “HLC-8020GPC” manufactured by TOSOH CORPORATION
Column: an ultra-high performance semi-micro SEC column (“TSKgel SuperMultipore HZ-H” manufactured by TOSOH CORPORATION, a filler: a styrene-divinylbenzene resin, a column size: inner diameter of 4.6 mm× length of 15 cm, a filler particle diameter: 6 μm)
Number of columns: 3
Eluent: tetrahydrofuran
Eluate flow rate: 0.35 mL/min
Amount of sample solution: 10 μL
Column temperature: 40° C.
Detector: refractive index (RI) detector
Calibration curve: calibration curve created using a monodisperse polystyrene standard sample (“F-40”, “F-20”, “F-4”, “F-1”, “A-5000”, “A-2500”, and “A-1000”) manufactured by TOSOH CORPORATION and n-propylbenzene.
   (Preparation of Copolymers (r-2) to (r-14))

Copolymers (r-2) to (r-14) were prepared in the same manner as that for the preparation of the copolymer (r-1) except that the type and amount of monomer to be used in the preparation of the monomer solution were changed as shown in the following Table 2. Note that in the following Table 2, “EG acrylate” indicates ethylene glycol acrylate. “DPGA” indicates dipropylene glycol acrylate.

### (Preparation of Aqueous Resin Solutions (R-1) to (R-14))

The copolymer (in detail, one of the copolymers (r-1) to (r-14)) as shown in the following Table 2, potassium hydroxide, and water were mixed to obtain aqueous specific resin solutions (R-1) to (R-14). The aqueous specific resin solutions (R-1) to (R-14) included a neutralized resin (corresponding to the specific resin). The amount of potassium hydroxide added was set to the amount that would make the neutralization ratio of the neutralized resin be as shown in the following Table 2. The amount of added water was set to the amount that would make the solid content concentration (the content ratio of the neutralized resin) of each of the aqueous specific resin solutions (R-1) to (R-14) 30 mass %.

TABLE 2

| | | Aqueous specific resin solution | | | | | | |
|---|---|---|---|---|---|---|---|---|
| | | R-1 | R-2 | R-3 | R-4 | R-5 | R-6 | R-7 |
| | | Copolymer | | | | | | |
| | | r-1 | r-2 | r-3 | r-4 | r-5 | r-6 | r-7 |
| Monomer | Styrene | 20 | 50 | 15 | 60 | — | 5 | 40 |
| [parts | α-methylstyrene | 40 | 20 | 15 | 10 | 50 | 70 | — |
| by mass] | EG acrylate | 5 | — | 1 | 4 | 5 | — | 5 |
| | DPGA | — | 9 | — | — | — | 5 | — |
| | Acrylic acid | — | 13 | — | 20 | 25 | — | 20 |
| | (Meth)acrylic acid | 25 | — | 20 | — | — | 10 | — |
| Physical | Acid value[mgKOH/g] | 181 | 110 | 255 | 165 | 243 | 72 | 239 |
| properties | Neutralization ratio[%] | 60 | 90 | 30 | 70 | 70 | 70 | 70 |
| | Mw | 9600 | 10200 | 5200 | 9400 | 8400 | 10600 | 6300 |

| | | Aqueous specific resin solution | | | | | | |
|---|---|---|---|---|---|---|---|---|
| | | R-8 | R-9 | R-10 | R-11 | R-12 | R-13 | R-14 |
| | | Copolymer | | | | | | |
| | | r-8 | r-9 | r-10 | r-11 | r-12 | r-13 | r-14 |
| Monomer | Styrene | 35 | 20 | 30 | 30 | 50 | 6 | 54 |
| [parts | α-methylstyrene | 35 | 40 | 35 | 25 | 20 | 12 | 108 |
| by mass] | EG acrylate | 15 | — | 10 | 10 | — | 2 | 14 |
| | DPGA | — | — | — | — | 9 | — | — |
| | Acrylic acid | — | 35 | 55 | — | 13 | — | — |
| | (Meth)acrylic acid | 30 | — | — | 5 | — | 6 | 68 |
| Physical | Acid value[mgKOH/g] | 170 | 286 | 329 | 46 | 110 | 150 | 181 |
| properties | Neutralization ratio[%] | 70 | 70 | 70 | 70 | 10 | 60 | 60 |
| | Mw | 12400 | 9300 | 12600 | 7900 | 10200 | 2800 | 26100 |

The content ratio [mass %] of each of the first repeating unit to the fourth repeating unit in the copolymers (r-1) to (r-14) is shown in the following Table 3.

TABLE 3

| Repeating unit | r-1 | r-2 | r-3 | r-4 | r-5 | r-6 | r-7 |
|---|---|---|---|---|---|---|---|
| First | 44 | 22 | 29 | 11 | 63 | 78 | — |
| Second | 22 | 54 | 29 | 64 | — | 6 | 62 |
| Third | 28 | 14 | 39 | 21 | 31 | 11 | 31 |
| Fourth | 6 | 10 | 2 | 4 | 6 | 6 | 8 |

| Repeating unit | r-8 | r-9 | r-10 | r-11 | r-12 | r-13 | r-14 |
|---|---|---|---|---|---|---|---|
| First | 30 | 42 | 27 | 36 | 22 | 46 | 44 |
| Second | 30 | 21 | 23 | 43 | 54 | 23 | 22 |
| Third | 26 | 37 | 42 | 7 | 14 | 23 | 28 |
| Fourth | 13 | — | 8 | 14 | 10 | 8 | 6 |

### <Preparation of Ink>

Inks according to Examples 1 to 8 and Comparative Examples 1 to 22 were prepared by the following method. First, the chemical name, the chemical formula, the epoxy equivalent, and the water solubility of each of cross-linking agents (EX-920), (EX-810), (EX-850), (EX-821), (EX-830), (EX-841), (EX-612), (EX-313), and (EX-145) (each of which is “DENACOL (registered trademark) series” manufactured by Nagase ChemteX Corporation) used in Examples are shown in the following Table 4. Note that the following Table 4, the chemical formula “(4-1)+ (4-2)” in the cross-linking agent (EX-313) indicates a mixture of the compound represented by the chemical formula (4-1) and the compound represented by the chemical formula (4-2).

TABLE 4

| | | | Epoxy | Water |
|---|---|---|---|---|
| Cross-linking | | Chemical | equivalent | solubility |
| agent | Chemical name | formula | [g/eq.] | [mass %] |
| EX-920 | Polypropylene glycol diglycidylether | (1-A1) | 176 | 100 |
| EX-810 | Ethylene glycol diglycidylether | (1-B1) | 113 | 100 |
| EX-850 | Polyethylene glycol diglycidylether | (1-B2) | 122 | 100 |
| EX-821 | Polyethylene glycol diglycidylether | (1-B3) | 185 | 100 |
| EX-830 | Polyethylene glycol diglycidylether | (2-A1) | 268 | 100 |
| EX-841 | Polyethylene glycol diglycidylether | (2-A2) | 372 | 100 |
| EX-612 | Sorbitol polyglycidylether | (3-1) | 166 | 42 |
| EX-313 | Glycerol polyglycidylether | (4-1) + (4-2) | 141 | 99 |
| EX-145 | Phenol (EO)₅ glycidylether | (4-3) | 400 | 100 |

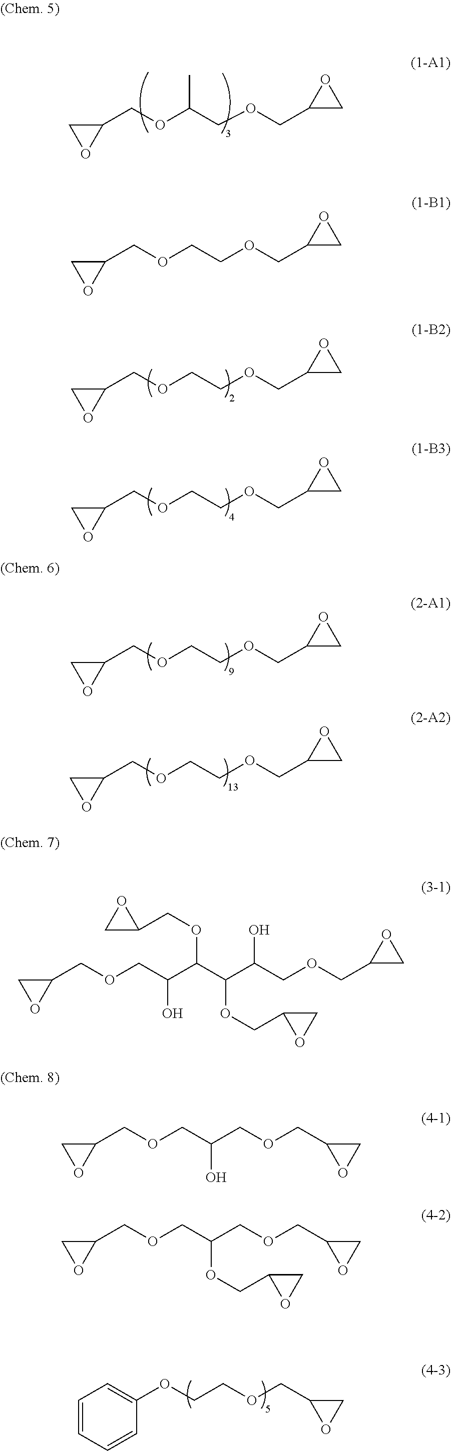

Of the respective cross-linking agents, the cross-linking agents (EX-920), (EX-810), (EX-850), and (EX-821) were each the first cross-linking agent. The cross-linking agents (EX-830) and (EX-841) were each the second cross-linking agent.

### Preparation of Ink According to Example 1

### (Dispersion)

15.0 parts by mass of a pigment (“Printex (registered trademark) 80” manufactured by Orion Engineered Carbons S.A., carbon black), 15.0 parts by mass of the above-mentioned aqueous specific resin solution (R-1) (including 4.5 parts by mass of the neutralized copolymer (r-1)), 0.1 parts by mass of an antifoaming agent (“SN-DEFOAMER 1340” manufactured by SAN NOPCO LIMITED, an amide wax surfactant), and ion exchanged water were mixed to obtain a mixture. The amount of ion exchanged water added was set to the amount that would make the mixture 100.0 parts by mass.

The above-mentioned mixture was dispersed for 4 hours using a media disperser (“DYNO (registered trademark)-MILL” manufactured by Willy A Bachofen AG (WAB)). In the dispersion, zirconia beads having a diameter of 0.5 mm were used as media. The filling rate of the media was set to 60% by volume with respect to the volume of the vessel. The treatment temperature (chiller temperature) in the dispersion was set to 10° C. After the dispersion, the media were removed from the content of the media disperser to obtain a pigment particle dispersion liquid. Next, the pigment particle dispersion liquid was filtered using a filter having a pore size of 5 μm to remove foreign substances and coarse particles.

### (Cross-Linking Treatment)

A three-necked flask equipped with a thermometer and a stirring blade was used as a reaction vessel. 100.0 parts by mass of the pigment particle dispersion liquid after filtration were added to the reaction vessel. The temperature of the content in the reaction vessel was maintained at 30° C. using a water bath. Next, 0.51 parts by mass of the cross-linking agent (EX-920) as the first cross-linking agent and 0.78 parts by mass of the cross-linking agent (EX-830) as the second cross-linking agent were added to the reaction vessel. Next, the content of the reaction vessel was stirred at 250 rpm for 1 hour. Next, the content of the reaction vessel was heated to 80° C. at the heating rate of 0.5° C./min while stirring the content of the reaction vessel at 250 rpm. Next, the content of the reaction vessel was stirred at 250 rpm for 4 hours while maintaining the temperature of the content of the reaction vessel at 80° C. In this way, the content of the reaction vessel was caused to react. Next, the content of the reaction vessel was allowed to cool until the temperature of the content reached room temperature. In this way, a pigment particle dispersion liquid after the cross-linking treatment was obtained.

In the pigment particle dispersion liquid according to Example 1, the cross-linking rate C₁ of the cross-linked resin by the first cross-linking agent, the cross-linking rate C₂ of the cross-linked resin by the second cross-linking agent, and the total cross-linking rate (C₁+C₂) of the cross-linked resin by the first cross-linking agent and the second cross-linking agent were calculated by the following method. Note that for convenience of calculation, they were calculated assuming that 1 parts by mass=1 g.

The number of moles X₁ of the epoxy groups included in the first cross-linking agent was calculated by dividing the amount of the first cross-linking agent used (0.51 g) by the epoxy equivalent of the first cross-linking agent (176 g/eq). In Example 1, the number of moles X₁ of the epoxy groups included in the first cross-linking agent was 2.90 mmol. The number of moles X₂ of the epoxy groups included in the second cross-linking agent was calculated by dividing the amount of the second cross-linking agent used (0.78 g) by the epoxy equivalent of the second cross-linking agent (268 g/eq). In Example 1, the number of moles X₂ of the epoxy groups included in the second cross-linking agent was 2.91 mmol.

Next, the number of moles Y of the carboxy groups included in the copolymer (r-1) after neutralization (i.e., the specific resin) was calculated. First, the number of moles of the carboxy groups per 1 g of the copolymer (r-1) after neutralization was calculated by dividing the acid value of the copolymer (r-1) (181 mgKOH/g) by the molecular weight of KOH (56.1). The number of moles of the carboxy groups per 1 g of the copolymer (r-1) after neutralization was 3.23 mmol/g. Next, the number of moles Y of the carboxy groups included in the copolymer (r-1) after neutralization was calculated by multiplying the amount of the copolymer (r-1) after neutralization used (4.5 g) and the number of moles of the carboxy groups per 1 g of the copolymer (r-1) after neutralization. The number of moles Y of the carboxy groups included in the copolymer (r-1) after neutralization was 14.54 mmol.

Next, by applying the values obtained as described above to the following formulae, the cross-linking rate C₁ of the cross-linked resin by the first cross-linking agent, the cross-linking rate C₂ of the cross-linked resin by the second cross-linking agent, and the total cross-linking rate (C₁+C₂) of the cross-linked resin by the first cross-linking agent and the second cross-linking agent were calculated.

Cross-linking rate C₁[%]=100×the number of moles X₁ of the epoxy groups included in the first cross-linking agent/the number of moles Y of the carboxy groups

Cross-linking rate C₂[%]=100×the number of moles X₂ of the epoxy groups included in the second cross-linking agent/the number of moles Y of the carboxy groups

Total cross-linking rate[%]=C₁+C₂

### (Centrifuging and Redispersion)

The pigment particle dispersion liquid after the cross-linking treatment was transferred to a container, and this container was placed in a centrifugal adhesion measurement apparatus (“NS-C100” manufactured by Nano Seeds Corporation). The above-mentioned pigment particle dispersion liquid after the cross-linking treatment was centrifuged at a rotational speed of 50000 rpm for 24 hours using the above-mentioned centrifugal adhesion measurement apparatus. After the centrifugation, the supernatant liquid was removed from the container, and then, ion exchanged water whose volume is the same as that of the removed supernatant liquid was added to the container. The precipitate of the container was then redispersed in the ion exchanged water. In this way, free components were removed from the aqueous medium of the pigment particle dispersion liquid after the cross-linking treatment.

### (Additive Treatment)

Each component was added to the container such that a composition 1 shown in the following Table 5 is obtained. Specifically, in Example 1, 60.0 parts by mass of the pigment particle dispersion liquid after redispersion (approximately 9 parts by mass of the pigment, approximately 3 parts by mass of the cross-linked resin), 20.0 parts by mass of ethylene glycol, 15.0 parts by mass of diethyl diglycol, 0.3 parts by mass of a nonionic surfactant (“OLFINE (registered trademark) E1004” manufactured by Nissin Chemical co., ltd.), and 4.7 parts by mass of ion exchanged water were added. The content of the above-mentioned container was stirred at a rotational speed of 400 rpm using a stirrer (“Three-One Motor BL-600” manufactured by Shinto Scientific Co., Ltd.) to obtain a mixture. The obtained mixed solution was filtered using a filter (pore size: 5 μm). In this way, the ink according to Example 1 was obtained.

### Preparation of Inks According to Examples 2 to 8 and Comparative Examples 1 to 22

Inks according to Examples 2 to 8 and Comparative Examples 1 to 22 were prepared in the same manner as that for the preparation of the ink according to Example 1 except that the type of aqueous specific resin solution used for dispersion, the type and amount of the first cross-linking agent and the second cross-linking agent used in cross-linking treatment, and the composition of the component to be added to the container in the additive treatment (one of the composition 1 to the composition 3 in the following Table 5) were changed as shown in the following Table 6.

TABLE 5

| | | Composition 1 | Composition 2 | Composition 3 |
|---|---|---|---|---|
| Composition | Pigment particle dispersion liquid | 60.0 | 60.0 | 60.0 |
| [parts | Ethylene glycol | 20.0 | — | — |
| by mass] | Diethyl diglycol | 15.0 | — | — |
| | Glycerin | — | 9.6 | — |
| | Triethylene glycol monobutylether | — | 12.0 | 8.4 |
| | 3-methyl-1,5-pentanediol | — | 12.0 | — |
| | 2-pyrrolidone | — | 1.6 | 1.7 |
| | 1,3-propanediol | — | — | 12.5 |
| | 1,5-pentanediol | — | — | 12.5 |
| | Nonionic surfactant | 0.3 | 0.3 | 0.3 |
| | Water | Remaining amount | Remaining amount | Remaining amount |
| | Total | 100.0 | 100.0 | 100.0 |

TABLE 6

| | Aqueous | | | | | | | Total cross- | | |
|---|---|---|---|---|---|---|---|---|---|---|
| | specific | First cross-linking agent | | | Second cross-linking agent | | | linking rate | | Additive |
| | resin | | C₁ | Amount | | C₂ | Amount | C₁ + C₂ | Ratio | treatment |
| | solution | Type | [%] | [parts] | Type | [%] | [parts] | [%] | C₂/C₁ | composition |
| Example 1 | R-1 | EX-920 | 20 | 0.51 | EX-830 | 20 | 0.78 | 40 | 50/50 | 1 |
| Example 2 | R-2 | EX-810 | 16 | 0.16 | EX-830 | 64 | 1.51 | 80 | 80/20 | 2 |
| Example 3 | R-3 | EX-850 | 64 | 1.60 | EX-830 | 16 | 0.88 | 80 | 20/80 | 3 |
| Example 4 | R-1 | EX-821 | 24 | 0.64 | EX-830 | 8 | 0.31 | 32 | 25/75 | 1 |
| Example 5 | R-2 | EX-920 | 52 | 0.81 | EX-841 | 42 | 1.37 | 94 | 45/55 | 1 |
| Example 6 | R-3 | EX-810 | 15 | 0.35 | EX-841 | 15 | 1.14 | 30 | 50/50 | 1 |
| Example 7 | R-1 | EX-850 | 16 | 0.28 | EX-841 | 64 | 3.46 | 80 | 80/20 | 2 |
| Example 8 | R-2 | EX-821 | 10 | 0.17 | EX-841 | 25 | 0.82 | 35 | 71/29 | 3 |
| Comparative | R-1 | EX-612 | 30 | 0.72 | EX-830 | 30 | 1.17 | 60 | 50/50 | 1 |
| Example 1 | | | | | | | | | | |
| Comparative | R-2 | EX-920 | 66 | 1.02 | EX-313 | 21 | 0.26 | 87 | 24/76 | 1 |
| Example 2 | | | | | | | | | | |
| Comparative | R-3 | EX-920 | 23 | 0.81 | EX-145 | 20 | 1.64 | 43 | 47/53 | 1 |
| Example 3 | | | | | | | | | | |
| Comparative | R-1 | EX-920 | 60 | 1.53 | — | — | — | 60 | — | 1 |
| Example 4 | | | | | | | | | | |
| Comparative | R-2 | — | — | — | EX-830 | 60 | 1.42 | 60 | — | 1 |
| Example 5 | | | | | | | | | | |
| Comparative | R-1 | EX-920 | 50 | 1.28 | EX-830 | 50 | 1.95 | 100 | 50/50 | 1 |
| Example 6 | | | | | | | | | | |
| Comparative | R-2 | EX-850 | 13 | 0.14 | EX-830 | 11 | 0.25 | 24 | 45/55 | 1 |
| Example 7 | | | | | | | | | | |
| Comparative | R-1 | EX-821 | 80 | 2.15 | EX-841 | 7 | 0.39 | 87 | 8/92 | 1 |
| Example 8 | | | | | | | | | | |
| Comparative | R-3 | EX-810 | 10 | 0.23 | EX-841 | 80 | 6.09 | 90 | 89/11 | 1 |
| Example 9 | | | | | | | | | | |
| Comparative | R-4 | EX-920 | 20 | 0.47 | EX-830 | 20 | 0.71 | 40 | 50/50 | 1 |
| Example 10 | | | | | | | | | | |
| Comparative | R-5 | EX-810 | 16 | 0.35 | EX-841 | 64 | 4.64 | 80 | 80/20 | 1 |
| Example 11 | | | | | | | | | | |
| Comparative | R-6 | EX-850 | 64 | 0.45 | EX-830 | 16 | 0.25 | 80 | 20/80 | 1 |
| Example 12 | | | | | | | | | | |
| Comparative | R-7 | EX-821 | 24 | 0.85 | EX-841 | 8 | 0.57 | 32 | 25/75 | 1 |
| Example 13 | | | | | | | | | | |
| Comparative | R-8 | EX-920 | 40 | 0.96 | EX-830 | 40 | 1.46 | 80 | 50/50 | 2 |
| Example 14 | | | | | | | | | | |
| Comparative | R-9 | EX-810 | 15 | 0.39 | EX-841 | 15 | 1.28 | 30 | 50/50 | 3 |
| Example 15 | | | | | | | | | | |
| Comparative | R-10 | EX-850 | 16 | 0.52 | EX-830 | 64 | 4.53 | 80 | 80/20 | 1 |
| Example 16 | | | | | | | | | | |
| Comparative | R-11 | EX-821 | 7 | 0.05 | EX-841 | 24 | 0.33 | 31 | 77/23 | 1 |
| Example 17 | | | | | | | | | | |
| Comparative | R-12 | EX-920 | 20 | 0.31 | EX-830 | 20 | 0.47 | 40 | 50/50 | 1 |
| Example 18 | | | | | | | | | | |
| Comparative | R-13 | EX-810 | 16 | 0.22 | EX-841 | 64 | 2.86 | 80 | 80/20 | 1 |
| Example 19 | | | | | | | | | | |
| Comparative | R-14 | EX-850 | 64 | 1.13 | EX-830 | 16 | 0.62 | 80 | 20/80 | 1 |
| Example 20 | | | | | | | | | | |
| Comparative | R-2 | EX-810 | 10 | 0.10 | EX-830 | 80 | 1.89 | 90 | 89/11 | 2 |
| Example 21 | | | | | | | | | | |
| Comparative | R-3 | EX-850 | 80 | 2.50 | EX-830 | 10 | 0.51 | 90 | 11/89 | 3 |
| Example 22 | | | | | | | | | | |

### [Measurement of Solids in Supernatant Liquid]

The inks according to Examples 1 to 8 and Comparative Examples 1 to 22 were centrifuged by the following methods. The content ratio of solids included in the obtained supernatant liquid was measured. Specifically, first, the measurement target (one of the inks according to Examples 1 to 8 and Comparative Examples 1 to 22) was centrifuged at a rotation speed of 140,000 rpm (1,050,000 G) for 3 hours using an ultracentrifuge (“himac (registered trademark) CS150FNX” manufactured by Eppendorf Himac Technologies Co., Ltd., rotor: S140AT). This cases the pigment particles included in the measurement target to be precipitated.

Next, 30 μL of the supernatant liquid included in the measurement target after the centrifugation was transferred to an aluminum container for thermogravimetric measurement. Next, the mass (A) of 30 μL of the supernatant liquid was measured. 1. Next, thermogravimetric analysis was performed in accordance with the scheme shown in the following Table 7 using a thermogravimetric analyzer (“TG/DTA7200” manufactured by Hitachi High-Tech Corporation). The reduced mass (B) of the measurement target between temperatures 200° C. and 500° C. was measured. The reduced mass (B) was regarded as the mass of solids (mainly free resins) in the supernatant liquid. The content ratio of solids in the supernatant liquid was calculated in accordance with the following formula. The measurement results are shown in the following Table 8.

Content ratio[mass %] of solids in supernatant liquid=100×B/A

TABLE 7

| | Start | Limit | Rate | Hold | |
|---|---|---|---|---|---|
| No. | [° C.] | [° C.] | [° C./min] | [min] | Atmosphere |
| 1 | 30 | 80 | 50 | 15 | N₂ |
| 2 | 80 | 200 | 50 | 15 | N₂ |
| 3 | 200 | 500 | 50 | 5 | Air atmosphere |

The content ratio of solids included in the supernatant liquid was judged as “A (favorable)” when it was 2.0 mass % or less and “B (unfavorable)” when it exceeded 2.0 mass %.

### <Evaluation>

For each of the inks according to Examples 1 to 8 and Comparative Examples 1 to 22, clogging of the nozzle and image density and abrasion resistance of the formed image were evaluated by the following method. The evaluation results are shown in the following Table 8.

### [Evaluation Device]

As an evaluation device, an inkjet recording apparatus (tester manufactured by KYOCERA Document Solutions Inc.) on which a line head was mounted was used. The ink tank for black of the evaluation device was filled with each of the inks according to Examples 1 to 8 and Comparative Examples 1 to 22 to be evaluated.

### [Clogging of Nozzle]

Clogging of the nozzle was evaluated in an environment of a temperature of 25° C. and a humidity of 60% RH. Inkjet matte paper (“Super Fine Paper” manufactured by Seiko Epson Corp.) was used as a recording medium. A solid image (150 mm×200 mm) was continuously formed on 100 recording media using the evaluation device. Next, a purge operation of purging an ink from the recording head of the evaluation device was performed. Next, a wipe operation of wiping the ink ejection surface of the recording head of the evaluation device with a cleaning wiper was performed (hereinafter, the operation of performing the wipe operation after performing the purge operation will be referred to as a cleaning operation in some cases). Next, a nozzle check pattern was formed on the above-mentioned matte paper using the evaluation device. The results confirmed that the ink was ejected from all (7968) nozzles in all evaluation targets. That is, the number of nozzles that clogged was zero. Next, the cleaning operation was performed on the recording head of the evaluation device. Next, the evaluation device was left to stand for 7 days while the recording head of the evaluation device is uncapped. Next, the cleaning operation was performed on the recording head of the evaluation device. Next, a nozzle check pattern was formed on the above-mentioned matte paper using the evaluation device. The formed nozzle check pattern was observed to check the number of nozzles that clogged. The ratio of the number of nozzles that clogged to the number of all nozzles of the recording head of the evaluation device was used as the evaluation value of the clogging of the nozzle. The clogging of the nozzle was judged in accordance with the following criteria.

### (Criteria for Clogging of Nozzle)

A (Good): the evaluation value is less than 10%.
B (Poor): the evaluation value exceeds 10% or more.

### [Image Density]

The image density was evaluated in an environment of a temperature of 25° C. and a humidity of 50% RH. PPC paper (“C²” manufactured by FUJIFILM Business Innovation Corp.) was used as a recording medium. A solid image of 10 cm×10 cm was formed on the recording medium using the evaluation device. In forming the solid image, the evaluation device was set such that the volume per drop of the ink ejected from the recording head was 11 pL (11 pL of the ink per pixel). The image density of the formed solid image was measured using a reflection densitometer (“RD-19” manufactured by X-Rite). In measuring the image density, the image density was measured at 10 positions randomly selected from the solid image and the arithmetic mean value of the image densities at the 10 positions was used as the evaluation value (ID) of the image density. The image density was judged in accordance with the following criteria.

### (Criteria for Image Density)

A (Good): ID is 1.15 or more.
B (Poor): ID is less than 1.15.

### [Abrasion Resistance]

In the evaluation of abrasion resistance, A4 size PPC paper (“C²” manufactured by FUJIFILM Business Innovation Corp.) was used as evaluation paper. First, the cleaning operation was performed on the recording head of the evaluation device. Next, a solid image (coverage rate of 100%) of 100 mm×100 mm was formed on the evaluation paper using the evaluation device. Unused evaluation paper (paper A) was placed on top of the evaluation paper on which the solid image was formed. Next, a rectangular weight of 1 kg was placed on top of the paper A. At this time, the weight was placed such that the center of gravity of the weight was directly above the center of the solid image. Next, the solid image was rubbed against the paper A (weight of 1 kg) by causing the paper A to move back and forth five times in a predetermined direction with the above-mentioned weight thereon. The image density of the stained image transferred from the solid image to the paper A was measured using a reflection densitometer (“FD-9” manufactured by Konica Minolta, Inc.). In detail, the image density was measured at 10 positions randomly selected from the stained image using the above-mentioned reflection densitometer, and the maximum value of the image densities at the 10 positions was used as the evaluation value of the abrasion resistance. The abrasion resistance was evaluated in accordance with the following criteria.

(Criteria for abrasion resistance)
A (Good): the evaluation value is less than 0.020.
B (Poor): the evaluation value is 0.020 or more.

TABLE 8

| | Solids in | | Clogging of nozzle | | | | Rubfastness | |
|---|---|---|---|---|---|---|---|---|
| | supernatant liquid | | | Evaluation | Image density | | | Evaluation |
| | Judgement | Mass % | Judgement | value[%] | Judgement | ID | Judgement | value |
| Example 1 | A | 1.4 | A | 6 | A | 1.19 | A | 0.015 |
| Example 2 | A | 0.8 | A | 5 | A | 1.15 | A | 0.013 |
| Example 3 | A | 1.1 | A | 7 | A | 1.18 | A | 0.018 |
| Example 4 | A | 1.8 | A | 9 | A | 1.16 | A | 0.019 |
| Example 5 | A | 0.7 | A | 5 | A | 1.15 | A | 0.012 |
| Example 6 | A | 1.7 | A | 7 | A | 1.18 | A | 0.019 |
| Example 7 | A | 0.9 | A | 6 | A | 1.15 | A | 0.011 |
| Example 8 | A | 1.6 | A | 8 | A | 1.16 | A | 0.016 |
| Comparative | B | 2.3 | B | 18 | B | 1.12 | A | 0.015 |
| Example 1 | | | | | | | | |
| Comparative | A | 1.2 | A | 8 | A | 1.15 | B | 0.021 |
| Example 2 | | | | | | | | |
| Comparative | B | 2.1 | B | 16 | A | 1.17 | B | 0.020 |
| Example 3 | | | | | | | | |
| Comparative | A | 1.7 | A | 9 | A | 1.18 | B | 0.022 |
| Example 4 | | | | | | | | |
| Comparative | A | 1.8 | A | 8 | B | 1.11 | A | 0.010 |
| Example 5 | | | | | | | | |
| Comparative | A | 1.8 | B | 14 | A | 1.15 | A | 0.016 |
| Example 6 | | | | | | | | |
| Comparative | B | 2.2 | B | 15 | A | 1.15 | B | 0.021 |
| Example 7 | | | | | | | | |
| Comparative | A | 1.6 | A | 8 | A | 1.16 | B | 0.022 |
| Example 8 | | | | | | | | |
| Comparative | A | 1.7 | A | 7 | B | 1.12 | A | 0.011 |
| Example 9 | | | | | | | | |
| Comparative | A | 1.9 | B | 22 | A | 1.16 | A | 0.019 |
| Example 10 | | | | | | | | |
| Comparative | B | 2.4 | B | 19 | A | 1.15 | A | 0.018 |
| Example 11 | | | | | | | | |
| Comparative | A | 1.8 | B | 24 | A | 1.18 | A | 0.017 |
| Example 12 | | | | | | | | |
| Comparative | B | 2.8 | B | 18 | A | 1.17 | A | 0.018 |
| Example 13 | | | | | | | | |
| Comparative | B | 2.2 | B | 23 | B | 1.10 | A | 0.015 |
| Example 14 | | | | | | | | |
| Comparative | A | 1.8 | B | 20 | A | 1.16 | B | 0.021 |
| Example 15 | | | | | | | | |
| Comparative | B | 2.5 | B | 16 | A | 1.15 | A | 0.015 |
| Example 16 | | | | | | | | |
| Comparative | A | 1.9 | B | 17 | A | 1.16 | A | 0.016 |
| Example 17 | | | | | | | | |
| Comparative | B | 2.2 | B | 13 | A | 1.15 | A | 0.018 |
| Example 18 | | | | | | | | |
| Comparative | A | 1.8 | B | 20 | A | 1.17 | A | 0.017 |
| Example 19 | | | | | | | | |
| Comparative | A | 2.0 | B | 26 | A | 1.18 | A | 0.019 |
| Example 20 | | | | | | | | |
| Comparative | A | 1.0 | A | 8 | B | 1.10 | A | 0.009 |
| Example 21 | | | | | | | | |
| Comparative | A | 1.2 | A | 9 | A | 1.20 | B | 0.020 |
| Example 22 | | | | | | | | |

The inks according to Examples 1 to 8 each included an aqueous medium, and a pigment particle dispersed in the aqueous medium. The pigment particle included a pigment and a cross-linked resin. The cross-linked resin was a cross-linked product of a specific resin, a first cross-linking agent, and a second cross-linking agent. The specific resin was a neutralized product of a specific copolymer including predetermined repeating units at a predetermined content ratio. The acid value of the specific copolymer was 50 mgKOH/g or more and 300 mgKOH/g or less. The mass average molecular weight of the specific copolymer was 3000 or more and 18000 or less. The neutralization ratio of the specific resin was 20% or more and 100% or less. The first cross-linking agent had, in its molecule, an ethylene oxide structure whose number of moles added is 1 or more and 4 or less or a propylene oxide structure whose number of moles added is 1 or more and 4 or less and two or more epoxy groups. The water solubility of the first cross-linking agent was 80% or more. The second cross-linking agent had, in its molecule, an ethylene oxide structure whose number of moles added is 5 or more and 15 or less and two or more epoxy groups. The water solubility of the second cross-linking agent was 80% or more. In the cross-linked resin, the ratio (C₂/C₁) was 18/82 or more and 82/18 or less. In the cross-linked resin, the total cross-linking rate (C₁+C₂) was 25% or more and 95% or less. The inks according to Examples 1 to 8 were each capable of forming images with desired image density and excellent abrasion resistance while preventing clogging of the nozzle.

On the other hand, in the ink according to Comparative Example 1, it can be judged that since the water solubility of the first cross-linking agent is less than 80%, the cross-linking of the cross-linked resin with the first cross-linking agent has not progress sufficiently. As a result, in the ink according to Comparative Example 1, the cross-linked resin forming the pigment particle was not sufficiently cross-linked and the content ratio of free resin increased. As a result, the ink according to Comparative Example 1 caused clogging of the nozzle. Further, in the ink according to Comparative Example 1, the hydrophilicity of the cross-linked resin was excessively high because the cross-linked resin was cross-linked by mainly the second cross-linking agent. As a result, in the ink according to Comparative Example 1, the image density of the formed image was evaluated as poor.

In the ink according to Comparative Example 2, a cross-linking agent that does not have, in its molecule, an ethylene oxide structure whose number of moles added is 5 or more and 15 or less was used as the second cross-linking agent. It can be judged that this cross-linking agent could not impart sufficient hydrophilicity to the cross-linked resin. As a result, in the ink according to Comparative Example 2, the hydrophilicity of the cross-linked resin was excessively low and the abrasion resistance of the formed image was evaluated as poor.

In the ink according to Comparative Example 3, a cross-linking agent that has, in its molecule, only one epoxy group was used as the second cross-linking agent. In the ink according to Comparative Example 3, since the second cross-linking agent is a cross-linking agent that cannot form an intermolecular cross-linked structure, the cross-linked resin was not sufficiently cross-linked and the content ratio of free resins increased. As a result, the ink according to Comparative Example 3 caused clogging of the nozzle. Further, in the ink according to Comparative Example 3, the abrasion resistance of the formed image was also evaluated as failure.

In the ink according to Comparative Example 4, the second cross-linking agent was not used. In the ink according to Comparative Example 4, since the cross-linked resin is cross-linked with only the first cross-linking agent, the hydrophilicity of the cross-linked resin was extremely low. As a result, in the ink according to Comparative Example 4, the abrasion resistance of the formed image was evaluated as poor. In the inks according to Comparative Examples 8 and 21, the ratio (C₂/C₁) was excessively small and the cross-linked resin was cross-linked with mainly the first cross-linking agent. As a result, for the inks according to Comparative Examples 8 and 21, results similar to that of the ink according to Comparative Example 4 were observed.

In the ink according to Comparative Example 5, the first cross-linking agent was not used. In the ink according to Comparative Example 5, since the cross-linked resin is cross-linked with only the second cross-linking agent, the hydrophilicity of the cross-linked resin was excessively high. As a result, in the ink according to Comparative Example 5, the image density of the formed image was evaluated as poor. In the inks according to Comparative Examples 9 and 22, the ratio (C₂/C₁) was excessively high and the cross-linked resin was cross-linked with mainly the second cross-linking agent. As a result, in the inks according to Comparative Examples 9 and 22, results similar to that of the ink according to Comparative Example 5 were observed.

In the ink according to Comparative Example 6, the cross-linking rate of the cross-linked resin was excessively high. As a result, it can be judged that in the ink according to Comparative Example 6, the hydrophilicity of the cross-linked resin was low and the dispersion stability of the pigment particles was insufficient. As a result, the ink according to Comparative Example 6 was unable to prevent clogging of the nozzle.

In the ink according to Comparative Example 7, the cross-linking rate of the cross-linked resin was excessively low. In the ink according to Comparative Example 7, since the cross-linked resin was not sufficiently cross-linked, the content ratio of free resins increased. As a result, in the ink according to Comparative Example 7 caused clogging of the nozzle. Further, in the ink according to Comparative Example 7, the abrasion resistance of the formed image was evaluated as poor.

In the inks according to Comparative Examples 10 to 17, the repeating unit included in the copolymer did not satisfy a predetermined configuration. Further, in the inks according to Comparative Examples 16 and 17, the acid value of the specific copolymer was excessively low or excessively high. As a result, it can be judged that in the inks according to Comparative Examples 10 to 17, the dispersion stability of the pigment particles was low and they were unable to prevent clogging of the nozzle. Further, in the inks according to Comparative Examples 14 and 15, one of the image density and abrasion resistance of the formed image was also evaluated as poor.

In the ink according to Comparative Example 18, the neutralization ratio of the specific resin was excessively low. As a result, it can be judged that in the ink according to Comparative Example 18, the dispersion stability of the pigment particles was low and it was unable to prevent clogging of the nozzle.

In the inks according to Comparative Examples 19 and 20, the mass average molecular weight of the specific copolymer was excessively small or excessively large. It can be judged that the inks according to Comparative Examples 19 and 20 were unable to efficiently cover the pigment with the specific copolymer because the molecular size of the specific copolymer was not appropriate. As a result, the inks according to Comparative Examples 19 and 20 were unable to prevent clogging of the nozzle.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
an aqueous medium; and
a pigment particle dispersed in the aqueous medium,
the pigment particle including a pigment and a cross-linked resin,
the cross-linked resin being a cross-linked product of a specific resin, a first cross-linking agent, and a second cross-linking agent,
the specific resin being a neutralized product of a specific copolymer that includes a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate,
with respect to 100 mass % of all repeating units included in the specific copolymer,
a content ratio of the first repeating unit being 1 mass % or more and 65 mass % or less,
a content ratio of the second repeating unit being 1 mass % or more and 60 mass % or less,
a content ratio of the third repeating unit being 10 mass % or more and 40 mass % or less,
a content ratio of the fourth repeating unit being 1 mass % or more and 12 mass % or less,
an acid value of the specific copolymer being 50 mgKOH/g or more and 300 mgKOH/g or less,
a mass average molecular weight of the specific copolymer being 3000 or more and 18000 or less,
a neutralization ratio of the specific resin being 20% or more and 100% or less,
the first cross-linking agent having, in its molecule, an ethylene oxide structure whose number of moles added is 1 or more and 4 or less or a propylene oxide structure whose number of moles added is 1 or more and 4 or less and two or more epoxy groups,
water solubility of the first cross-linking agent being 80% or more,
the second cross-linking agent having, in its molecule, an ethylene oxide structure whose number of moles added is 5 or more and 15 or less and two or more epoxy groups,
water solubility of the second cross-linking agent being 80% or more,
a ratio (C₂/C₁) of a cross-linking rate C₂ by the second cross-linking agent to a cross-linking rate C₁ by the first cross-linking agent in the cross-linked resin being 18/82 or more and 82/18 or less,
a total cross-linking rate (C₁+C₂) by the first cross-linking agent and the second cross-linking agent in the cross-linked resin being 25% or more and 95% or less.

2. The inkjet ink according to claim 1, wherein
a content ratio of solids in the supernatant liquid obtained by centrifuging at 1,050,000 G for 3 hours is 2.0 mass % or less.

3. The inkjet ink according to claim 1, wherein
the first cross-linking agent includes at least one of compounds represented by the following general formulae (1-A) and (1-B); 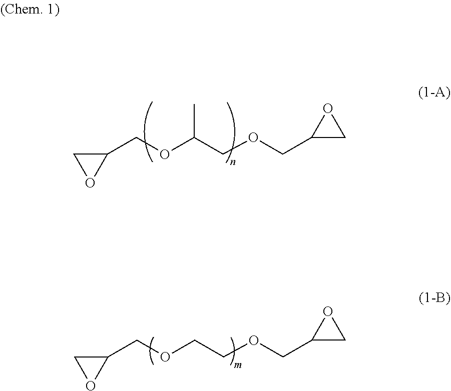
in the general formula (1-A), n represents an integer of 1 or more and 4 or less, and
in the general formula (1-B), m represents an integer of 1 or more and 4 or less.

4. The inkjet ink according to claim 3, wherein
the first cross-linking agent includes at least one of compounds represented by the following chemical formulae (1-A1), (1-B1), (1-B2), and (1-B3);

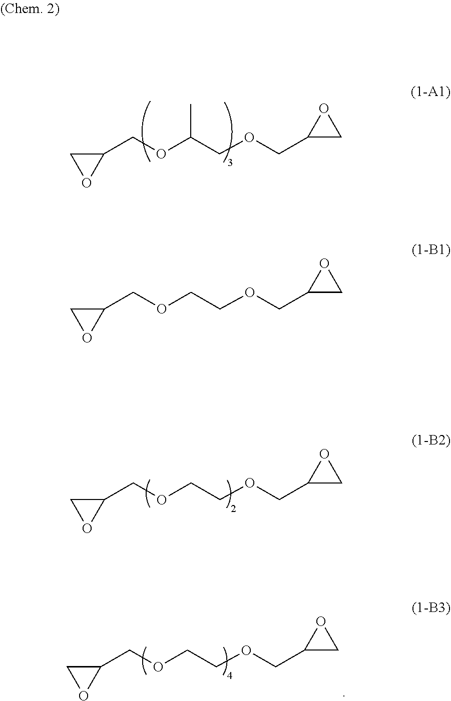

5. The inkjet ink according to claim 1, wherein
the second cross-linking agent includes a compound represented by the following general formula (2-A); 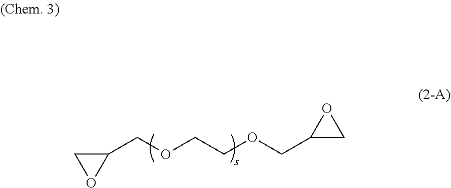
in the general formula (2-A), s represents an integer of 5 or more and 15 or less.

6. The inkjet ink according to claim 5, wherein
the second cross-linking agent includes at least one of compounds represented by the following general formulae (2-A1) and (2-A2);

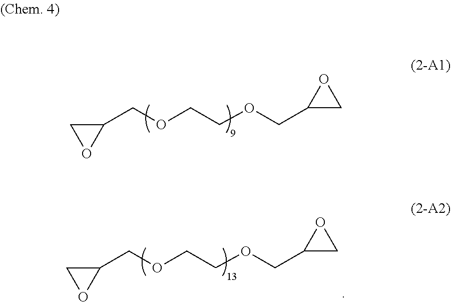

7. The inkjet ink according to claim 1, wherein
with respect to 100 mass % of all repeating units included in the specific copolymer,
a content ratio of the first repeating unit is 15 mass % or more and 55 mass % or less,
a content ratio of the second repeating unit is 10 mass % or more and 40 mass % or less,
a content ratio of the third repeating unit is 20 mass % or more and 35 mass % or less, and
a content ratio of the fourth repeating unit is 4 mass % or more and 11 mass % or less.

8. The inkjet ink according to claim 1, wherein
an epoxy equivalent of the first cross-linking agent is 100 g/eq. or more and 230 g/eq. or less.

9. The inkjet ink according to claim 1, wherein
an epoxy equivalent of the second cross-linking agent is 250 g/eq. or more and 450 g/eq. or less.

10. A method of producing an inkjet ink that includes an aqueous medium and a pigment particle dispersed in the aqueous medium, comprising:
a neutralization step of neutralizing a specific copolymer to obtain a specific resin, the pigment particle including a pigment and a cross-linked resin;
a dispersion step of dispersing the specific resin and the pigment in water to obtain a pigment particle dispersion liquid; and
a cross-linking step of cross-linking the specific resin in the pigment particle dispersion liquid with a first cross-linking agent and a second cross-linking agent to obtain the cross-linked resin,
the specific copolymer including a first repeating unit derived from α-methylstyrene, a second repeating unit derived from styrene, a third repeating unit derived from (meth)acrylic acid, and a fourth repeating unit derived from alkylene glycol (meth)acrylate or dialkylene glycol (meth)acrylate,
with respect to 100 mass % of all repeating units included in the specific copolymer,
a content ratio of the first repeating unit being 1 mass % or more and 65 mass % or less,
a content ratio of the second repeating unit being 1 mass % or more and 60 mass % or less,
a content ratio of the third repeating unit being 10 mass % or more and 40 mass % or less,
a content ratio of the fourth repeating unit being 1 mass % or more and 12 mass % or less,
an acid value of the specific copolymer being 50 mgKOH/g or more and 300 mgKOH/g or less,
a mass average molecular weight of the specific copolymer being 3000 or more and 18000 or less,
a neutralization ratio of the specific resin in the neutralization step being 20% or more and 100% or less,
the first cross-linking agent having, in its molecule, an ethylene oxide structure whose number of moles added is 1 or more and 4 or less or a propylene oxide structure whose number of moles added is 1 or more and 4 or less and two or more epoxy groups,
water solubility of the first cross-linking agent being 80% or more,
the second cross-linking agent having, in its molecule, an ethylene oxide structure whose number of moles added is 5 or more and 15 or less and two or more epoxy groups,
water solubility of the second cross-linking agent being 80% or more,
a ratio (C₂/C₁) of a cross-linking rate C₂ by the second cross-linking agent to a cross-linking rate C₁ by the first cross-linking agent in the cross-linking step being 18/82 or more and 82/18 or less,
a total cross-linking rate (C₁+C₂) of the cross-linked resin by the first cross-linking agent and the second cross-linking agent being 25% or more and 95% or less.

11. The method of producing an inkjet ink according to claim 10, further comprising:
a centrifugation step of centrifuging the pigment particle dispersion liquid after the cross-linking step to obtain a precipitate; and
a redispersion step of redispersing the precipitate in water.
